(19) United States
(12) Patent Application Publication
(10) Pub. No.: US 2006/0077139 A1
(43) Pub. Date: Apr. 13, 2006

(54) Data driver and light emitting display using the same

(76) Inventor: Oh-Kyong Kwon, Suwon-si (KR)

Correspondence Address: CHRISTIE, PARKER & HALE, LLP, PO BOX 7068, PASADENA, CA, 91109-7068, US

(21) Appl. No.: 11/228,920

(22) Filed: Sep. 16, 2005

(30) Foreign Application Priority Data
Oct. 8, 2004 (KR) 10-2004-0080370

(51) Int. Cl. G09G 3/30

(52) U.S. Cl. 345/76

(57) ABSTRACT

A data driver for reducing the number of digital-analog (D/A) converters and a light emitting display device using the data driver. The data driver respectively applies data signals corresponding to data lines of a display panel, and includes a multiplexing unit, a D/A converting unit, and an output signal controller. The multiplexing unit outputs the plurality of data signals after sequentially selecting the plurality of data signals. The D/A converting unit sequentially converts the plurality of data signals sequentially transmitted from the multiplexing unit into analog data signals. The output signal controller respectively applies the data signal converted by the D/A converting unit to the corresponding data lines.

### CROSS-REFERENCE TO RELATED APPLICATION

This application claims priority to and the benefit of Korean Patent Application No. 10-2004-0080370, filed in the Korean Intellectual Property Office on Oct. 8, 2004, the entire content of which is incorporated herein by reference.

### FIELD OF THE INVENTION

The present invention relates to a light emitting display device. More specifically, the present invention relates to a data driver for applying a data current to a display element and a light emitting display device using the data driver.

### BACKGROUND OF THE INVENTION

In general, a light emitting display device is a display device using electric field light emission of organic materials, and it displays an image by driving N×M organic light emitting cells using a voltage driving method or a current driving method. In the light emitting display device, the N×M organic light emitting cells are arranged in a matrix format.

The organic light emitting cell has characteristics of a diode, and can be referred to as an organic light emitting diode (OLED). The OLED includes an anode, an organic thin film, and a cathode. The organic thin film is formed as a multi-layered structure including an emission layer (EML), an electron transport layer (ETL), and a hole transport layer (HTL) so as to increase luminescence efficiency by balancing electron and hole concentrations. In addition, the organic thin film may separately include an electron injection layer (EIL) and a hole injection layer (HIL). The N×M organic light emitting cells arranged in a matrix format form an OLED display panel.

According to an addressing method, methods for driving the organic light emitting cells may be classified into a passive matrix method or an active matrix method using thin film transistors (TFTs) or metal-oxide semiconductor field-effect transistors (MOSFETs). In the passive matrix method, the organic light emitting cells are formed between anode lines and cathode lines perpendicularly crossing the anode lines, and driven by selecting the respective lines. In the active matrix method, a thin film transistor is coupled to each pixel electrode (e.g., an anode line), and the organic light emitting cells are driven according to a voltage maintained by capacitance of a capacitor coupled to a gate of a thin film transistor.

Further, depending on formats of signals applied to the capacitor for maintaining the voltage after programming the voltage to the capacitor, the active matrix method may be categorized as either a voltage programming method or a current programming method.

In the voltage programming method, a data voltage based on an image data signal to be displayed is applied to respective pixel circuits. The data voltage has various values within a predetermined range so as to express predetermined brightness grayscales. However, the pixel circuit according to the voltage programming method has difficulties in obtaining high grayscales because of deviations in threshold voltages and/or in electron mobilities of thin film transistors, the deviations being caused by non-uniformity of a manufacturing process.

In the current programming method, a data current based on the image data signal to be displayed is respectively applied. The data current has various values within a predetermined range so as to express predetermined brightness grayscales. According to the current programming method, uniform display characteristics are achieved even though driving transistors in each pixel have non-uniform voltage-current characteristics, provided that a current source for supplying the current to the pixel is uniform throughout the whole panel (i.e., all the data lines).

FIG. 1 shows a diagram of a configuration of a data driver in a conventional organic light emitting diode (OLED) display.

As shown in FIG. 1, the data driver applying a data voltage or a data current to respective pixel circuits of a display panel includes a shift register 10, a sampling latch 20, a holding latch 30, a level shifter 40, a digital-analog (D/A) converting unit 50, and an output buffer 60.

The shift register 10 sequentially generates latch clock signals after receiving timing signals CLK and SP. The sampling latch 20 latches digital image signals DB_R, DB_G, DB_B received when the latch clock signals move upward or downward, and sequentially stores the digital image signals. The holding latch 30 holds the digital data after receiving digital data from the sampling latch 20. The level shifter 40 shifts a level of the digital data signal to a predetermined level. The D/A converting unit 50 converts the shifted digital data signal into an analog signal, and includes a plurality of D/A converters (DACs) corresponding to respective data lines. The output buffer 60 outputs the converted data signal to the respective data lines.

As shown in FIG. 1, the data driver generally has a separate DAC for each data line. That is, for example, when one data driver applies the data signals to 300 to 480 data lines, 300 to 480 respective DACs are required to be integrated into the data driver.

However, in the OLED display using the current programming method, it is necessary to provide a current mode DAC to the data driver because the D/A converting unit 50 outputs currents. It is difficult to separately provide one D/A converter (or DAC) for each output data line because a current mode DAC generally occupies a large space.

The information disclosed in this Background of the Invention section is only for enhancement of understanding of the background of the invention, and therefore, unless explicitly described to the contrary, it should not be taken as an acknowledgment or any form of suggestion that this information forms the prior art that is already known in this country to a person of ordinary skill in the art.

### SUMMARY OF THE INVENTION

An embodiment of the present invention provides a data driver for reducing the number of digital-analog (D/A) converters (or DACs).

Also, an embodiment of the present invention provides a light emitting display device using a data driver for reducing the number of D/A converters.

An exemplary data driver for respectively applying data signals corresponding to a plurality of data lines of a display panel according to an embodiment of the present invention includes a multiplexing unit for sequentially outputting a plurality of digital data signals, a digital/analog (D/A) converting unit for sequentially converting the digital data signals into analog data signals, and an output signal controller for controlling an application of the respective analog data signals to the corresponding data lines.

In another embodiment, a light emitting display device includes a display unit, a data driver, and a scan driver. The display unit includes a plurality of scan lines for transmitting selection signals, a plurality of data lines for transmitting data signals, and a plurality of pixels coupled to the scan lines and the data lines. The data driver is for generating the data signals and respectively applying the data signals to the data lines, and the scan driver is for generating the selection signals and respectively applying the selection signals to the scan lines. The data driver includes a first shift register for sequentially shifting and generating a first shift signal according to external signals, a latch unit for sampling and storing the data signals having first and second group of data signals in synchronization with the first shift signal, first and second multiplexing units for sequentially transmitting the respective first and second group of data signals outputted from the latch unit, first and second D/A converting units for respectively converting the first and second group signals into analog signals, and an output signal controller for controlling an application of the data signals converted by the first and second D/A converters to the corresponding data lines.

In another embodiment, a light emitting display panel includes a plurality of scan lines for transmitting selection signals, a plurality of data lines for transmitting data signals, a plurality of pixels coupled to the scan lines and the data lines, a scan driver for generating the selection signals and respectively applying the selection signals to corresponding scan lines, and a data driver for generating the data signals and respectively applying the data signals to corresponding data lines. The data driver includes a multiplexing unit for sequentially outputting a plurality of data signals having digital values, a D/A converting unit for sequentially converting the data signals sequentially transmitted from the multiplexing unit into corresponding analog data currents, and an output signal controller for controlling an application of the respective data currents converted by the D/A converting unit to the corresponding data lines.

In another embodiment, a light emitting display panel includes a display unit, a scan driver, and a data driver. The display unit includes a plurality of scan lines for transmitting selection signals, a plurality of data lines for transmitting data signals, and a plurality of pixels coupled to the scan lines and the data lines and arranged in a matrix format. The scan driver is for generating the selection signals and respectively applying the selection signals to the corresponding scan lines, and the data driver is for generating the data signals and respectively applying the data signals to the corresponding data lines. The data driver includes a first shift register for sequentially shifting and generating a first shift signal according to external signals, a latch unit for sampling and storing the data signals having first and second group of data signals in synchronization with the first shift signal, first and second multiplexing units for sequentially transmitting the first and second group of data signals outputted from the latch unit, first and second D/A converting units for converting the first and second group signals into analog signals, and an output signal controller for controlling an application of the data signals sequentially outputted from the first and second D/A converters to the corresponding data lines.

In a method for driving a light emitting display device, according to another embodiment, digital data signals are sampled and stored by a latch unit in synchronization with a plurality of shift signals, the respective digital data signals outputted from the latch unit are sequentially transmitted, the transmitted digital data signals are respectively converted into analog signals in sequence, and the converted data signals are controlled to be outputted to corresponding data lines.

### BRIEF DESCRIPTION OF THE DRAWINGS

FIG. 1 shows a diagram of a configuration of a data driver of a conventional OLED display.

FIG. 2 shows a schematic diagram of a configuration of a light emitting display device according to a first embodiment of the present invention.

FIG. 3 shows a diagram of a pixel circuit according to a current programming method for driving an organic light emitting diode.

FIG. 4 shows a diagram of a configuration of a data driver shown in FIG. 2.

FIG. 5 shows a diagram of a configuration of a first multiplexing unit.

FIG. 6 shows a diagram of a configuration of a second multiplexing unit.

FIG. 7 shows a diagram of a configuration of a DAC_R of a first D/A converter.

FIG. 8 shows a diagram of a configuration of a light emitting display device according to a second embodiment of the present invention.

FIG. 9 shows a diagram of a configuration of a data driver of FIG. 8.

FIG. 10 shows a diagram of a configuration of a multiplexing unit.

FIG. 11 shows a diagram of a configuration of a D/A converter.

FIG. 12 shows a diagram of a configuration of a DAC_R.

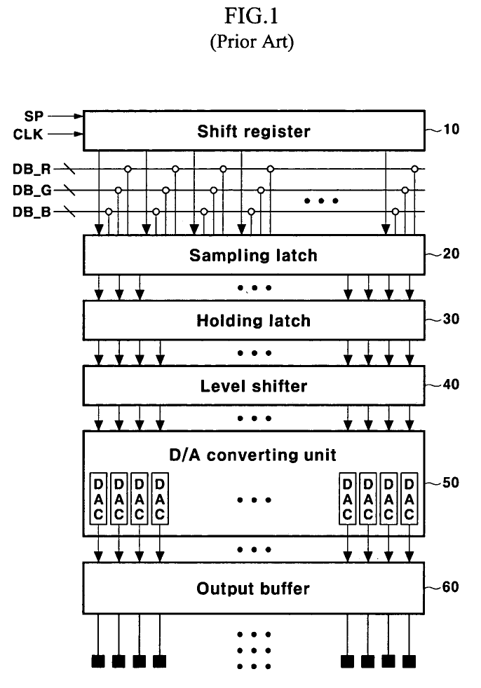

### DETAILED DESCRIPTION

An embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature, and not restrictive. Like reference numerals designate like elements throughout the specification.

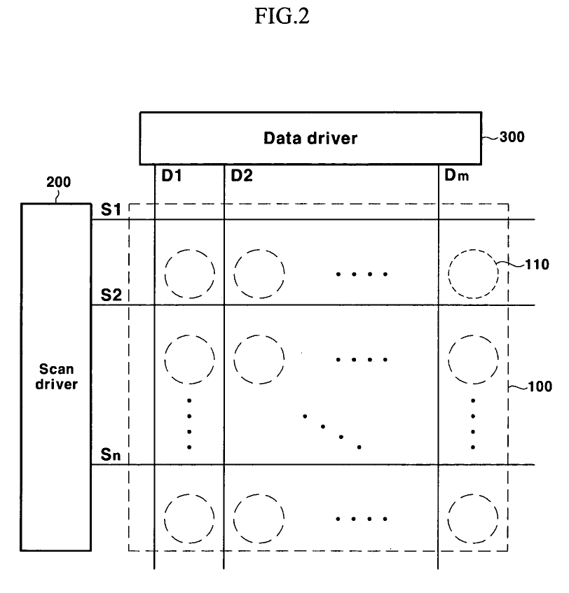

FIG. 2 shows a schematic diagram of a configuration of a light emitting display device according to a first embodiment of the present invention.

The light emitting display device includes a display panel 100, a scan driver 200, and a data driver 300.

The display panel 100 includes a plurality of data lines D1 to Dm elongated in a column direction, a plurality of scan lines S1 to Sn elongated in a row direction, and a plurality of pixel circuits 110. The data lines D1 to Dm are for transmitting data signals representing image signals to the pixel circuits 110, and the scan lines S1 to Sn are for transmitting selection signals to the pixel circuits 110. A pixel circuit 110 is formed in a pixel area defined by two neighboring data lines and two neighboring scan lines.

The scan driver 200 sequentially applies selection signals to the respective scan lines S1 to Sn. The data driver 300 applies data currents corresponding to red R, green G, and blue B image signals to the data lines D1 to Dm.

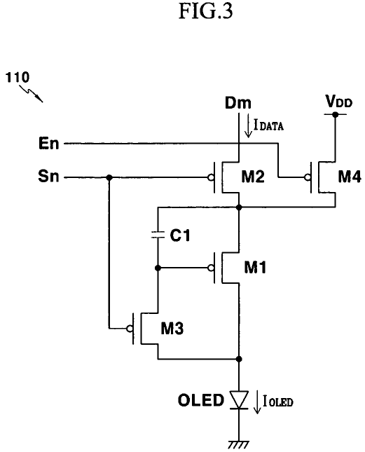

Hereinafter, the light emitting display device according to the first embodiment of the present invention will be described with reference to FIG. 3.

FIG. 3 shows a diagram of a pixel circuit 110 according to a current programming method for driving an organic light emitting diode (OLED). Referring to FIG. 3, a transistor M1 is coupled to an OLED to transmit a current for emitting a light, and the amount of current of the transistor M1 is controlled by a data current I_{DATA} applied through a transistor M2.

In operation, when the transistor M2 and a transistor M3 are turned on by a selection signal from a scan line Sn, the transistor M1 is diode-connected, and a voltage corresponding to the data current I_{DATA} from a data line Dm is stored by a capacitor C1. The transistors M2 and M3 are then turned off when the selection signal from the scan line Sn is at a high level, and a transistor M4 is turned on because an emission signal from the scan line En is now at a low level. An emission is then generated since power is supplied from a power voltage source VDD and a current corresponding to the voltage stored in the capacitor C1 flows to the OLED. At this time, the current I_{OLED} flowing to the OLED is given as Equation 1.

$${I}_{OLED} = \frac{β}{2} {( {V}_{GS} - {V}_{TH} )}^{2} = {I}_{DATA} \qquad [ Equation 1 ]$$

Here, V_{GS} denotes a voltage between a source and a gate of the transistor M1, and V_{TH} denotes a threshold voltage of the transistor M1, and β denotes a constant value.

Next, a data driver of the light emitting display operating in the current programming method will be described.

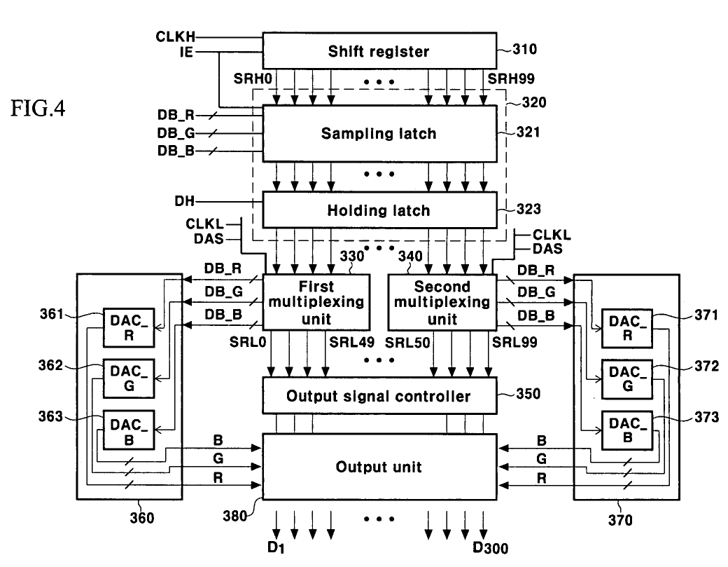

FIG. 4 shows a diagram of a configuration of the data driver 300 shown in FIG. 2.

The data driver 300 includes a shift register (or a first shift register) 310, a latch unit 320, first and second digital-analog (D/A) converting units 360 and 370, first and second multiplexing units 330 and 340, an output signal controller 350, and an output unit 380.

The shift register 310 generates shift signals based on a clock signal. The latch unit 320 samples and stores red (R), green (G), and blue (B) data signals DB_R, DB_G, and DB_B inputted based on the shift signals. The first and second D/A converting units 360 and 370 respectively convert the digital R, G, and B data signals into analog data signals. The first and second multiplexers 330 and 340 transmit a group of the digital R, G, and B data signals (a first group data signals) among the digital R, G, and B data signals stored in the latch unit 320 to the first D/A converting unit 360, and transmit another group of the digital R, G, and B data signals (a second group data signals) to the second D/A converting unit 370, respectively. The output signal controller 350 controls the analog data signals outputted from the first and second D/A converting units 360 and 370 to be applied to corresponding data lines. The output unit 380 applies the data signals to the data lines under the control of the output signal controller 350.

Hereinafter, an operation of the data driver 300 will be described. According to an exemplary embodiment of the present invention, the data driver 300 receives respective 10-bit R, G, and B digital data, generates data corresponding to 100 channels for the respective R, G, and B digital data (i.e., a total of 300 channels), and applies the data of the 300 channels to 300 corresponding data lines. However, the invention is not limited to the disclosed exemplary embodiment of the data driver 300.

In more detail, a clock signal CLKH and an input enable signal IE are externally inputted to the shift register 310. The shift register 310 then sequentially outputs 100 shift signals SRH0 to SRH99 for data sampling based on the clock signal CLKH and the input enable signal IE. In the exemplary embodiment of the present invention, the number of data lines of the display panel is 300, and the number of shift signals is 100 because 100 channels are provided for the respective R, G, and B data.

While not illustrated in FIG. 4, the shift register 310 may bidirectionally output the shift signals. (I.e., the shift register 310 may output shift signals shifted from left to right or shift signals shifted from right to left.) When the shift register 310 is capable of performing a bidirectional output, a control signal for determining a direction and a carry-in signal are inputted, and based on the control signal and the carry-in signal, the shift signals shifted from left to right or the shift signals shifted from right to left may selectively be outputted.

The latch unit 320 for sampling and storing the R, G, and B data signals includes a sampling latch 321 and a holding latch 323. The sampling latch 321 samples the inputted 10-bit R, G, and B digital data signals DB_R, DB_G, and DB_B as respective 100 channel data by using the shift signals SRH0 to SRH99 inputted from the shift register 310 as sampling clock signals.

That is, the sampling latch 321 receives the shift signals SRH0 to SRH99 outputted from the shift register 310 as sampling clock signals, and samples each of the 10-bit R, G, and B digital data for each sampling clock signal (i.e., a total of 30-bit data for each sampling clock signal).

The holding latch 323 holds the data for one row line time (i.e., time for sampling one row of data signals by the sampling latch 321) after receiving the data DB_R<0-99>, DB_G<0-99>, and DB_B<0-99> corresponding to the 100 channels for the respective R, G, and B data (i.e., total 300 channels). The holding latch 323 concurrently stores the data in parallel based on a holding-latch-enable signal DH. At this time, the holding-latch-enable signal DH may be used in synchronization with an internal clock signal (CLK′) or the clock signal CLKH not directly inputted to the holding latch 323. Since the enable signal DH is synchronized with the internal clock signal (CLK′) or the clock signal CLKH, the operation of the holding latch 323 is not affected even though an enable-signal-DH condition may be unexpectedly and suddenly varied by an external noise. The enable signal DH drives 100 buffers in the holding latch 323. Each of the 100 buffers drives three elements for data holding (e.g., three flip flops), and therefore all the digital data DB_R<0-99>, DB_G<0-99>, and DB_B<0-99> corresponding to the 300 channels may be stored in the holding latch 323.

The first multiplexing unit 330 includes a shift register (or a second shift register) 331 and a multiplexer 332, and the second multiplexing unit 340 includes a shift register (or a third shift register) 341 and a multiplexer 342.

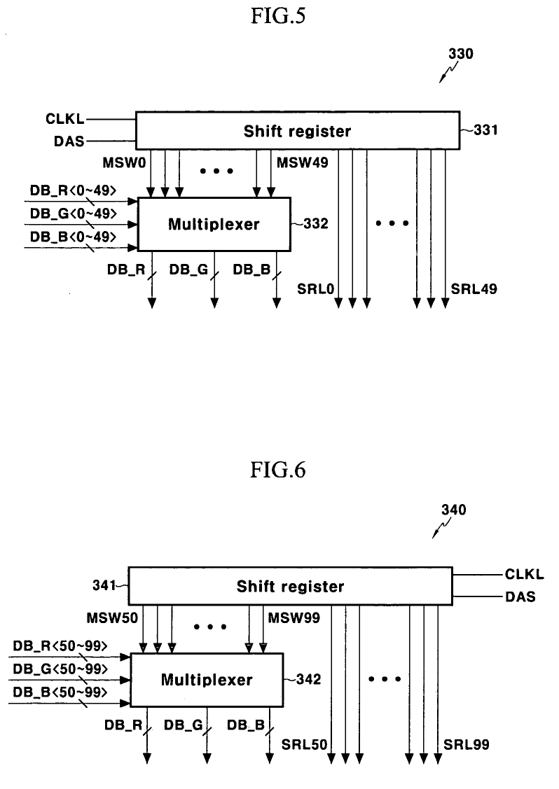

FIG. 5 and FIG. 6 show diagrams of configurations of the first and second multiplexing units 330 and 340. As shown in FIG. 5 and FIG. 6, the shift register 331 of the first multiplexing unit 330 generates signals MSW0 to MSW49 and signals SRL0 to SRL49 when receiving a clock signal CLKL and a carry-in signal DAS, and the shift register 341 of the second multiplexing unit 340 generates signals MSW50 to MSW99 and signals SRL50-SRL99 when receiving the clock signal CLKL and the carry-in signal DAS. At this time, a frequency of the clock signal CLKL applied to the shift register 331 may be lower than the same of the clock signal CLKH applied to the shift register 310. A timing of the carry-in signal DAS is equal to the same of the enable signal DH used in the holding latch 323. A type of the signals MSW0 to MSW49 is equal to the same of the signals MSW50 to MSW99, and a type of the signals SRL0 to SRL49 is equal to the same of the signals SRL50 to SRL99.

The signals MSW0 to MSW49 are applied to the multiplexer 332 of the first multiplexing unit 330, and the signals MSW50 to MSW99 are applied to the multiplexer 342 of the second multiplexing unit 340. In addition, the signals SRL0 to SRL49 and the signals SRL50 to SRL99 are outputted to the output signal controller 350 of FIG. 4.

The multiplexer 332 of the first multiplexing unit 330 sequentially applies the data DB_R<0-49>, DB_G<0-49>, and DB_B<0-49> of 50 channels for the respective R, G, and B data to the first D/A converting unit 360 of FIG. 4 based on the signals MSW0 to MSW49. At this time, the data DB_R<0-49>, DB_G<0-49>, DB_B<0-49> corresponds to a first group data among the data DB_R<0-99>, DB_G<0-99>, and DB_B<0-99> of the 100 channels for the respective R, G, and B data stored in the holding latch 323.

The multiplexer 342 of the second multiplexing unit 340 sequentially applies the data DB_R<50-99>, DB_G<50-99>, DB_B<50-99> of the 50 channels for the respective R, G, and B data to the second D/A converting unit 370 based on the signals MSW50 to MSW99. At this time, data DB_R<50-99>, DB_G<50-99>, DB_B<50-99> corresponds to a second group data among the data DB_R<0-99>, DB_G<0-99>, and DB_B<0-99> of the 100 channels for the respective R, G, and B data stored in the holding latch 323.

Referring now also to FIG. 4, the first and the second D/A converting units 360 and 370 respectively include three digital analog converters DACs for converting the R, G, and B data into analog current signals and outputting the converted analog current signals. In more detail, after sequentially converting the first group data DB_R<0-49>, DB_G<0-49>, and DB_B<0-49> received through the multiplexer 332 of the first multiplexing unit 330 into the analog current signals by respectively using a DAC_R 361, a DAC_G 362, and a DAC_B 363, the first D/A converting unit 360 outputs the converted analog current signals. Also, after sequentially converting the second group data DB_R<50-99>, DB_G<50-99>, and DB_B<50-99> received through the multiplexer 342 of the second multiplexing unit 340 into the analog current signals by respectively using a DAC_R 371, a DAC_G 372, and a DAC_B 373, the second D/A converting unit 370 outputs the converted analog current signals.

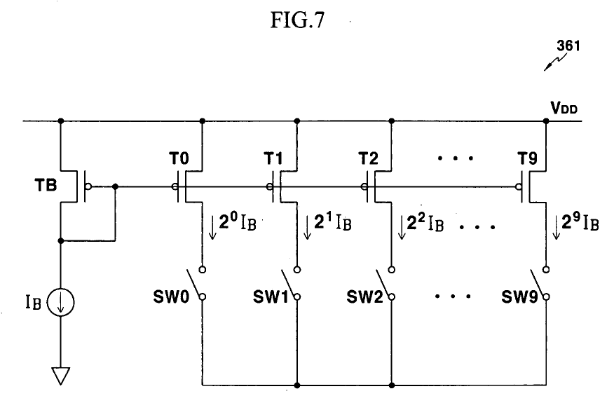

FIG. 7 shows a diagram of a configuration of the DAC_R 361 of the first D/A converting unit 360. Configurations and operations of the other DACs of the first and second D/A converting units 360 and 370 are substantially the same as those of the DAC_R 361 of the first D/A converting unit 360, and therefore are not described in more detail.

As shown in FIG. 7, the DAC_R 361 includes a transistor TB coupled to a current source IB, 10 mirror transistors T0 to T9, and switches SW0 to SW9 coupled to the mirror transistors T0 to T9.

Sizes of the mirror transistors T0 to T9 are 2⁰ to 2⁹ times the size of the transistor TB. Accordingly, the mirror transistors T0 to T9 respectively output currents 2⁰IB to 2⁹IB, which are respectively 2⁰ to 2⁹ times of a current IB flowing through the transistor TB. The switches SW0 to SW9 respectively couple the mirror transistors T0 to T9 to an output terminal by being turned on in response to a one data bit of the data DB_R received from the multiplexer 332 of the first multiplexer 330. For example, when the data DB_R is 0010100010, an output current is (2¹+2⁵+2⁷)IB because the switches SW1, SW5, and SW7 are turned on. Accordingly, the R, G, and B data currents generated by being converted into analog current values by the first and second D/A converting units 360 and 370 are inputted to the output unit 380 of FIG. 4.

In FIG. 4, the output signal controller 350 controls an application of the data currents sequentially outputted from the first and second D/A converting units 360 and 370 to corresponding output data lines based on the input signals SRL0 to SRL99 generated by the shift register of the first and second multiplexing units 330 and 340.

The output unit 380 applies the 300 channel data signals outputted from the first and second D/A converting units 360 and 370 to the corresponding data lines D1 to Dm.

In the light emitting display device according to the first embodiment of the present invention, space needed for the DACs in a data driver may be greatly reduced because a predetermined number of channels use one DAC in common instead of separately providing a DAC for each output channel. In addition, a data deviation caused by conversion of the channel data may be reduced because the plurality of channel data is converted by a common DAC.

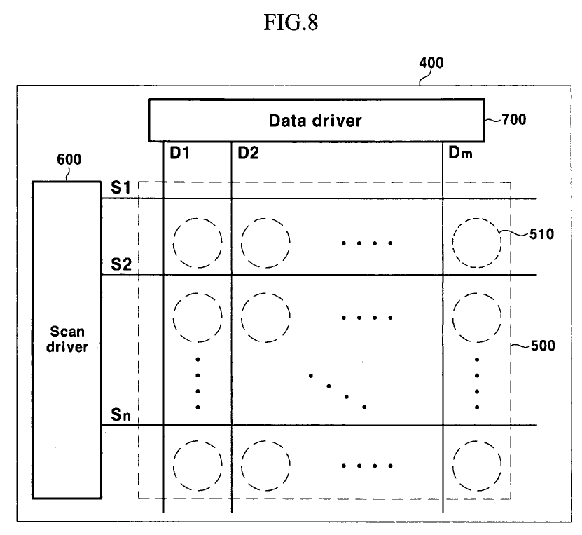

A light emitting display device according to a second embodiment of the present invention will be described with reference to FIG. 8 to FIG. 12.

As shown in FIG. 8, in the second embodiment, a scan driver and a data driver are integrated with one substrate 400 in a light emitting display device in contrast with the first embodiment of the present invention.

The light emitting display device formed in the one substrate 400 includes a display area 500, a scan driver 600, and a data driver 700.

The display area 500 includes a plurality of data lines D1 to Dm elongated in a column direction, a plurality of scan lines S1 to Sn elongated in a row direction, and a plurality of pixel circuits 510. The data lines D1 to Dm are for transmitting data signals representing image signals to the pixel circuits 510, and the scan lines S1 to Sn are for transmitting selection signals to the pixel circuits 510. A pixel circuit 510 is formed in a pixel area defined by two neighboring data lines and two neighboring scan lines. The scan driver 600 sequentially applies selection signals to the respective scan lines S1 to Sn. The data driver 700 applies data currents corresponding to R, G, and B image signals to the data lines D1 to Dm.

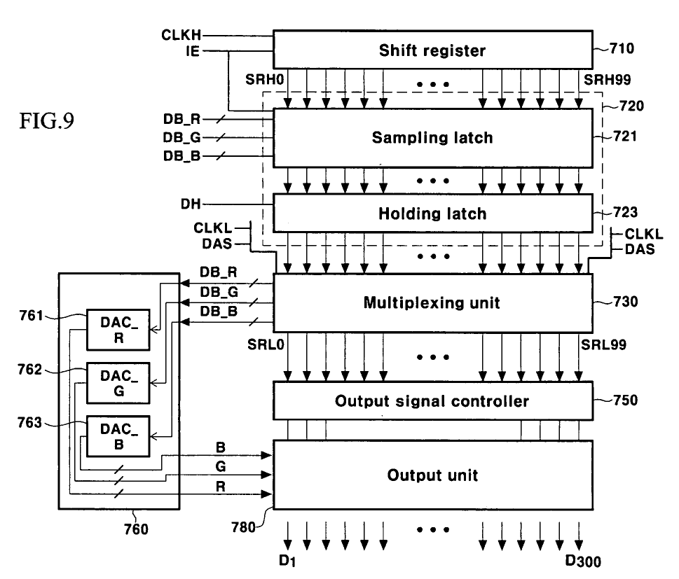

FIG. 9 shows a diagram of a configuration of the data driver 700 of FIG. 8.

Here, the data driver 700 includes one multiplexing unit 730 and one D/A converting unit 760 in contrast with the first embodiment of the present invention. To follow, descriptions of components, configurations, and operations that are substantially the same as in the first embodiment will not be described in more detail, and components, configurations, and operations of the multiplexing unit 730 and the D/A converting unit 760 will be described in more detail.

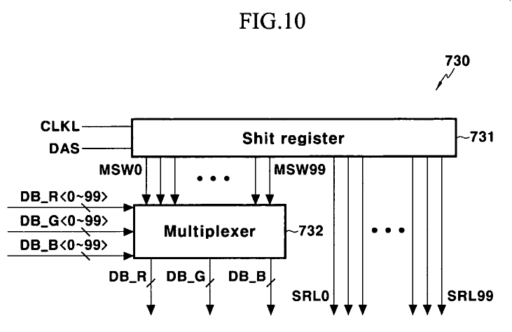

FIG. 10 shows a diagram of a configuration of the multiplexing unit 730.

As shown in FIG. 10, the multiplexing unit 730 includes a shift register 731 and a multiplexer 732. The shift register 731 of the multiplexing unit 730 generates signals MSW0 to MSW99 and signals SRL0 to SRL99 when receiving a clock signal CLKL and a carry-in signal DAS.

The signals MSW0 to MSW99 are applied to the multiplexer 732 of the multiplexing unit 730, and the signals SRL0 to SRL99 are outputted to the output signal controller 750.

The multiplexer 732 of the multiplexing unit 730 sequentially applies data DB_R<0-99>, DB_G<0-99>, and DB_B<0-99> of 100 channels for the respective R, G, and B data stored in a holding latch 723 of FIG. 9 to the D/A converting unit 760 of FIG. 9 based on the signals MSW0 to MSW99.

The D/A converting unit 760 includes three DACs for respectively outputting R, G, and B data by respectively converting the R, G, and B data into analog current signals. In more detail, the D/A converting unit 760 sequentially converts the respective 100 channel digital data DB_R<0-99>, DB_G<0-99>, and DB_B<0-99> into the analog current signals by respectively using a DAC_R 761, a DAC_G 762, and a DAC_B 763. At this time, the respective 100 channel digital data are received through the multiplexer 732 of the multiplexing unit 730.

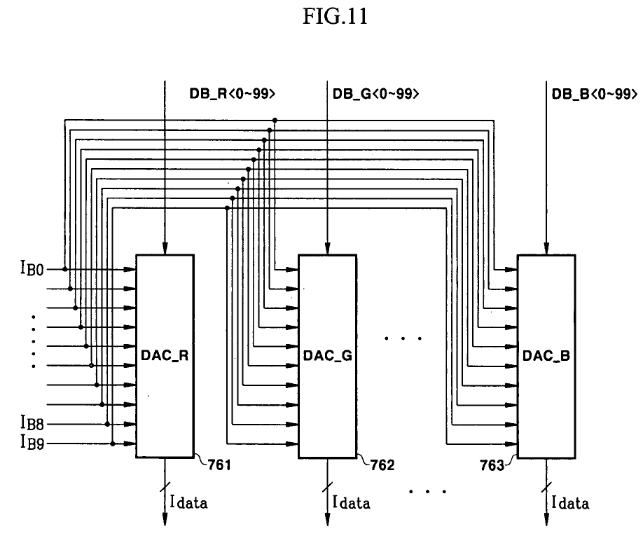

FIG. 11 shows a diagram of a configuration of the D/A converting unit 760.

In FIG. 11, the D/A converting unit 760 includes a DAC_G 761, a DAC_G 762, and a DAC_B 763. The DAC_R 761 sequentially generates data current values corresponding to the respective digital data DB_R<0-99> and outputs the data current value to an output unit 780 of FIG. 9 after sequentially receiving red digital data DB_R<0-99> from the multiplexing unit 730 and bias currents IB0 to IB9 generated and outputted from a bias current generator (not shown). The DAC_G 762 sequentially generates data current values corresponding to the respective digital data DB_G<0-99> and outputs the data current value to the output unit 780 after sequentially receiving green digital data DB_G<0-99> from the multiplexing unit 730 and the bias currents IB0 to IB9 generated and outputted from the bias current generator. The DAC_B 763 sequentially generates data current values corresponding to the respective digital data DB_B<0-99> and outputs the data current value to an output unit 780 after sequentially receiving blue digital data DB_B<0-99> from the multiplexing unit 730 and the bias currents IB0 to IB9 generated and outputted from the bias current generator. The respective DAC_R 761, DAC_G 762, and DAC_B 763 include current sample/hold circuits corresponding to the number of bits of the data. Ten (10) bias currents IB0 to IB9 are received because the digital data DB_G, DB_G, and DB_B are respectively 10 bits in the second embodiment of the present invention. That is, the number of the received bias currents may be varied according to the digital data DB_G, DB_G, and DB_B.

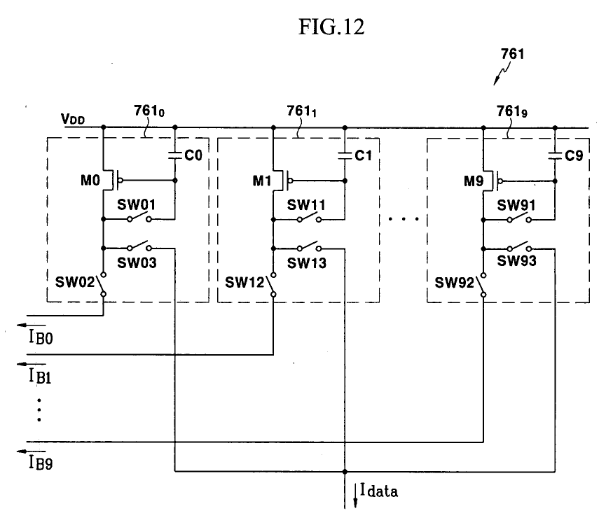

FIG. 12 shows a diagram of a configuration of the DAC_R 761. Configurations and operations of the DAC_G 762 and the DAC_B 763 are substantially the same as those of the DAC_R 761, and therefore will not be described in more detail.

As shown in FIG. 12, the DAC_R 761 includes 10 current circuits 761₀ to 761₉. For convenience of description, the current circuit 761₀ will representatively be described among the current circuits 761₀ to 761₉. The current circuit 761₀ includes a transistor M0, a capacitor C0, and switches SW01, SW02, and SW03.

The transistor M0 is formed as a P-channel MOS transistor, and has a source coupled to a power voltage source VDD. The capacitor C0 is coupled between a gate and the source of the transistor M0. The switch SW01 is coupled between a drain and the gate of the transistor M0, and is turned on in response to a bias signal for copying a bias current after a current path is formed from the voltage source VDD. The switch SW02 is coupled between an input terminal of the DAC_R 761₀ receiving the bias current and the drain of the transistor M0, and is turned on in response to the bias signal for copying the bias current after a current path is formed from the voltage source VDD. The switch SW03 is coupled between the drain of the transistor M0 and an output terminal, and is turned on in response to a first bit of the data DB_R.

Accordingly, when the bias signal for copying the bias current after a current path is formed from the voltage source VDD is inputted, the current path is formed because the switch SW01 and the switch SW02 are turned on. The bias current IB0 flows through the current path, and a voltage corresponding to the bias current IB0 is stored in the capacitor C0.

Then, when the switches SW01 and SW02 are turned off and the data DB_R is inputted, the switch SW03 is turned on in a case that the first bit of the data DB_R is 1. Accordingly, a current corresponding to the voltage stored in the capacitor C0 flows through the transistor M0 to the output terminal. In a case that the first bit of the data DB_R is 0, the switch SW03 is turned off, and the current from the transistor M0 is interrupted. In one embodiment, the current circuits are formed to correspond to the number of the bits of the data DB_R. In FIG. 12, a data current corresponding to the 10-bit data may be outputted by respectively applying first to tenth bits of grayscale data to the switches SW03 to SW93 of the respective current circuits 7610 to 7619. For example, in a case that the data DB_R is 0100010100, switches SW23, SW43. SW83 of the third, fifth, and ninth current circuits 761₂, 761₄, 761₈ from the left of FIG. 12 are turned on, and therefore currents corresponding to voltages stored in capacitors C2, C4, and C8 are outputted to the output terminal.

According to the second embodiment of the present invention, the space for mounting the DAC or D/A converter may be further reduced by using one D/A converter in common instead of providing an individual D/A converter for each output channel.

While it has been described to use one or two D/A converters (or D/A converting units) in the exemplary embodiments of the present invention, three or more D/A converters (or D/A converting units) for sequentially converting a plurality of channel data into analog data may be used. In addition, while the light emitting display device according to the exemplary embodiments of the present invention have been exemplified, an exemplary embodiment of the present invention may cover various other suitable display devices requiring a data driver.

According to the exemplary embodiments of the present invention, space for digital-analog converters in a data driver may be greatly reduced since a plurality of channel data use one digital-analog converter in common.

In addition, a data deviation caused by conversion of the channel data may be reduced because the plurality of channel data are converted by a same digital-analog converter.

In view of the foregoing, display characteristics of a display device may be further improved by using a data driver according to the exemplary embodiments of the present invention.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A data driver for respectively applying data signals corresponding to a plurality of data lines of a display panel, the data driver comprising:
a multiplexing unit for sequentially outputting a plurality of digital data signals;
a digital-analog (D/A) converting unit for sequentially converting the plurality of digital data signals into a plurality of analog data signals; and
an output signal controller for controlling an application of the respective analog data signals to the corresponding data lines.

2. The data driver of claim 1, wherein the multiplexing unit comprises:
a shift register for generating a first shift signal; and
a multiplexer for sequentially applying the plurality of digital data signals to the D/A converting unit in synchronization with the first shift signal.

3. The data driver of claim 2, wherein:
the shift register generates a second shift signal; and
the output signal controller controls the application of the respective analog data signals to the corresponding data lines in synchronization with the second shift signal.

4. The data driver of claim 1, wherein the D/A converting unit comprises three digital-analog converters for respectively converting red (R), green (G), and blue (B) digital data signals.

5. The data driver of claim 1, wherein the plurality of digital data signals are grouped into a plurality of groups of digital data signals including first and second groups of digital data signals, and the multiplexing unit comprises:
a first multiplexing unit for sequentially outputting the first group of digital data signals; and
a second multiplexing unit for sequentially outputting the second group of digital data signals.

6. The data driver of claim 5, wherein the D/A converting unit comprises:
a first D/A converting unit for sequentially converting the first group of digital data signals into a first group of the plurality of analog data signals; and
a second D/A converting unit for sequentially converting the second group of digital data signals into a second group of the plurality of analog data signals.

7. A light emitting display device comprising:
a display unit comprising a plurality of scan lines for transmitting selection signals, a plurality of data lines for transmitting data signals, and a plurality of pixels coupled to the scan lines and the data lines,
a data driver for generating the data signals and respectively applying the data signals to the data lines, and
a scan driver for generating the selection signals and respectively applying the selection signals to the scan lines,
wherein the data driver comprises:
a first shift register for sequentially shifting and generating a first shift signal according to external signals;
a latch unit for sampling and storing the data signals including first and second group of data signals in synchronization with the first shift signals;
a first multiplexing unit for sequentially transmitting the first group of data signals outputted from the latch unit;
a second multiplexing unit for sequentially transmitting the second group of data signals outputted from the latch unit;
a first digital-analog (D/A) converting unit for converting the first group of data signals into a first group of analog signals;
a second D/A converting unit for converting the second group of the data signals into a second group of analog signals; and
an output signal controller for controlling an application of the data signals converted by the first and second D/A converters to the corresponding data lines.

8. The light emitting display device of claim 7, wherein the first multiplexing unit comprises:
a second shift register for generating a second shift signal and a third shift signal; and
a multiplexer for sequentially outputting the first group of data signals outputted from the latch unit to the first D/A converting unit in synchronization with the second shift signal generated by the shift register.

9. The light emitting display device of claim 8, wherein the second multiplexing unit comprises:
a third shift register for generating a fourth shift signal and a fifth shift signal; and
a multiplexer for sequentially outputting the second group of data signals outputted from the latch unit to the second D/A converting unit in synchronization with the fourth shift signal generated from the shift register.

10. The light emitting display device of claim 9, wherein the second shift signal and the fourth shift signal are of a same type.

11. The light emitting display device of claim 9, wherein
the output signal controller controls the application of the respective data signals converted by the first and second D/A converting units to the corresponding data lines in synchronization with the third and fifth shift signals.

12. The light emitting display device of claim 7, wherein
the first and second D/A converting units comprise three digital-analog converters for respectively converting red, green, and blue data signals.

13. A light emitting display panel comprising:
a plurality of scan lines for transmitting selection signals;
a plurality of data lines for transmitting data signals;
a plurality of pixels coupled to the scan lines and the data lines;
a scan driver for generating the selection signals and respectively applying the selection signals to corresponding scan lines; and
a data driver for generating the data signals and respectively applying the data signals to corresponding data lines,
wherein the data driver comprises
a multiplexing unit for sequentially outputting a plurality of data signals having digital values,
a D/A converting unit for sequentially converting the data signals sequentially transmitted from the multiplexing unit into corresponding analog data currents, and
an output signal controller for controlling an application of the respective data currents converted by the D/A converting unit to the corresponding data lines.

14. The light emitting display panel of claim 13, wherein the multiplexing unit comprises:
a shift register for generating a first shift signal and a second shift signal; and
a multiplexer for sequentially applying the plurality of data signals to the D/A converting unit in synchronization with the first shift signal.

15. The light emitting display panel of claim 14, wherein
the output signal controller controls the application of the respective data signals converted by the D/A converting unit to the corresponding data lines in synchronization with the second shift signal.

16. A light emitting display panel comprising:
a display unit comprising a plurality of scan lines for transmitting selection signals, a plurality of data lines for transmitting data signals, and a plurality of pixels coupled to the scan lines and the data lines and arranged in a matrix format;
a scan driver for generating the selection signals and respectively applying the selection signals to the corresponding scan lines; and
a data driver for generating the data signals and respectively applying the data signals to the corresponding data lines,
wherein the data driver comprises
a first shift register for sequentially shifting and generating a first shift signal according to external signals,
a latch unit for sampling and storing the data signals having first and second group of data signals in synchronization with the first shift signal,
first and second multiplexing units for sequentially transmitting the first and second group of data signals outputted from the latch unit,
first and second D/A converting units for converting the first and second group of data signals into analog signals, and
an output signal controller for controlling an application of the data signals sequentially outputted from the first and second D/A converters to the corresponding data lines.

17. The light emitting display panel of claim 16, wherein:
the first multiplexing unit comprises a second shift register for generating second and third shift signals, and a multiplexer for sequentially outputting the first group of data signals outputted from the latch unit to the first D/A converting unit in synchronization with the second shift signal generated by the shift register; and
the second multiplexing unit comprises a third shift register for generating fourth and fifth shift signals, and a multiplexer for sequentially outputting the second group of data signals outputted from the latch unit to the second D/A converting unit in synchronization with the fourth shift signal generated by the shift register.

18. The light emitting display panel of claim 17, wherein the output signal controller controls the application of the respective data signals converted by the first and second D/A converting units to the corresponding data lines in synchronization with the third and fifth shift signals.

19. The light emitting display panel of claim 16, wherein each of the first and second D/A converting unit comprises three current type digital-analog converters for respectively converting red, green, and blue data signals into analog data currents.

20. A method for driving a light emitting display device, comprising:
sampling and storing digital data signals by a latch unit in synchronization with a plurality of shift signals;
sequentially transmitting the respective digital data signals outputted from the latch unit;
respectively converting the transmitted digital data signals into analog signals in sequence; and
controlling the converted data signals to be outputted to the corresponding data lines.
